(19) United States
(12) Patent Application Publication
(10) Pub. No.: US 2025/0362083 A1
(43) Pub. Date: Nov. 27, 2025

(54) FURNACE

(71) Applicants: NGK INSULATORS, LTD., Nagoya-Shi (JP); NGK KILNTECH, CORPORATION, Nagoya-Shi (JP)

(72) Inventors: Michihiro ITO, Nagoya-Shi (JP); Shinichi MURASHITA, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 19/185,455

(22) Filed: Apr. 22, 2025

(30) Foreign Application Priority Data
May 27, 2024 (JP) 2024-085347

(51) Int. Cl. F27B 9/02

(52) U.S. Cl. CPC F27B 9/028

(57) ABSTRACT

A furnace configured to heat a treatment object is provided, and the furnace may include: a furnace body including an entrance, an exit, and an internal space extending in a conveying direction from the entrance to the exit; and a conveying device having a conveying surface which carries the object thereon and conveys the object in the conveying direction. The internal space may include: a preheating space communicated with the entrance and which preheats the object; a temperature-maintained space communicated with the preheating space and which heats the object, wherein a temperature in the temperature-maintained space is maintained constant; and a cooling space communicated with the temperature-maintained space and the exit and which cools the object. When the furnace body is cut along a plane perpendicular to the conveying direction, a cross-sectional area of the temperature-maintained space may be greater than a cross-sectional area of the preheating space.

### CROSS REFERENCE TO RELATED APPLICATION(S)

This application claims priority from Japanese Patent Application No. 2024-85347 filed on May 27, 2024. The entire content of the priority application is incorporated herein by reference.

### TECHNICAL FIELD

The disclosure herein relates to a furnace.

### BACKGROUND ART

Japanese Patent Application Publication No. 2023-507663 describes a furnace. A furnace body of the furnace has an entrance, an exit, and an internal space extending in a conveying direction from the entrance to the exit. The internal space includes: a preheating space communicated with the entrance; a temperature-maintained space communicated with the preheating space; and a cooling space communicated with the temperature-maintained space and the exit. When the furnace body is cut along a plane perpendicular to the conveying direction, a cross-sectional area of the temperature-maintained space is smaller than a cross-sectional area of the preheating space.

In the above-mentioned furnace, since a capacity of atmospheric gas in the temperature-maintained space is small, variation caused by disturbance in the atmosphere in the temperature-maintained space tends to become great, which results in increased occurrence of variation in the temperature in the temperature-maintained space. Due to this, variation occurs in an amount of heating (heating amount) on a treatment object in the temperature-maintained space.

### SUMMARY

The present teachings provide an art configured to suppress variation in a heating amount on a treatment object in a temperature-maintained space.

In a first aspect of the art disclosed herein, a furnace configured to heat a treatment object is provided, and the furnace may include: a furnace body including an entrance, an exit, and an internal space extending in a conveying direction from the entrance to the exit; and a conveying device having a conveying surface configured to carry the treatment object thereon and configured to convey the treatment object in the conveying direction. The internal space may include: a preheating space communicated with the entrance and configured to preheat the treatment object; a temperature-maintained space communicated with the preheating space and configured to heat the treatment object, wherein a temperature in the temperature-maintained space is maintained constant; and a cooling space communicated with the temperature-maintained space and the exit and configured to cool the treatment object. When the furnace body is cut along a plane perpendicular to the conveying direction, a cross-sectional area of the temperature-maintained space may be greater than a cross-sectional area of the preheating space.

According to the above configuration, as compared to a configuration where the cross-sectional area of the temperature-maintained space is smaller than the cross-sectional area of the preheating space when the furnace body is cut along the plane perpendicular to the conveying direction, variation caused by disturbance in the atmosphere in the temperature-maintained space is small, resulting in less variation in the temperature in the temperature-maintained space. Due to this, occurrence of variation in the heating amount on a treatment object can be suppressed.

### BRIEF DESCRIPTION OF DRAWINGS

FIG. 1 illustrates a schematic view of a furnace according to a first embodiment.

FIG. 2 illustrates a schematic view of a preheating space and its surroundings of the furnace according to the first embodiment.

FIG. 3 illustrates a schematic view when the furnace according to the first embodiment is cut along a plane perpendicular to a conveying direction.

FIG. 4 illustrates a schematic view of a cooling space and its surroundings of the furnace according to the first embodiment.

FIG. 5 illustrates a schematic view of a furnace according to a second embodiment.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved furnaces as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the art disclosed herein according to the first aspect, when the furnace body is cut along a plane perpendicular to the conveying direction, the cross-sectional area of the temperature-maintained space may be greater than a cross-sectional area of the cooling space. According to the above configuration, the atmospheric gas in the temperature-maintained space can be suppressed from flowing into the cooling space. Due to this, the temperature of the cooling space can be easily adjusted.

In a third aspect of the art disclosed herein according to the second aspect, when the furnace body is cut along a plane perpendicular to the conveying direction, the cross-sectional area of the cooling space may be smaller than the cross-sectional area of the preheating space. Due to this, the temperature of the cooling space can more easily be adjusted.

In a fourth aspect of the art disclosed herein according to the second or third aspect, when the furnace body is cut along a plane perpendicular to the conveying direction, a height of the temperature-maintained space may be equal to or greater than 1.1 times a height of the cooling space. According to the above configuration, the atmospheric gas in the temperature-maintained space can further be suppressed from flowing into the cooling space. Due to this, the temperature of the cooling space can more easily be adjusted.

In a fifth aspect of the art disclosed herein according to the fourth aspect, the height of the cooling space may decrease in steps toward the exit. According to the above configuration, the atmospheric gas in the temperature-maintained space can further be suppressed from flowing deep into the cooling space. Due to this, the temperature of the cooling space can more easily be adjusted.

In a sixth aspect of the art disclosed herein according to the fifth aspect, the cooling space may comprise: a first cooling space a height of which is a first height; and a second cooling space communicated with the first cooling space, located in the conveying direction with respect to the first cooling space, and a height of which is a second height. The second height may be equal to or less than 0.9 times the first height. A length of the first cooling space in the conveying direction and a length of the second cooling space in the conveying direction may be each equal to or greater than a length of the treatment object in the conveying direction. According to the above configuration, the atmospheric gas in the temperature-maintained space can further be suppressed from flowing into the second cooling space. Due to this, the temperature of the cooling space can more easily be adjusted.

In a seventh aspect of the art disclosed herein according to any one of the fourth to sixth aspects, when the furnace body is cut along a plane perpendicular to the conveying direction, an inner width of the temperature-maintained space may be greater than an inner width of the cooling space. According to the above configuration, the temperature of the cooling space can be easily adjusted.

In an eighth aspect of the art disclosed herein according to any one of the first to seventh aspects, the preheating space may comprise a first preheating space. When the furnace body is cut along a plane perpendicular to the conveying direction, a height of the temperature-maintained space may be equal to or more than 1.1 times a height of the first preheating space. According to the above configuration, there will be less variation in the temperature of the temperature-maintained space. Due to this, generation of variation in the heating amount on a treatment object can be suppressed in the temperature-maintained space.

In a ninth aspect of the art disclosed herein according to the eighth aspect, the preheating space may further comprise a second preheating space communicated with the first preheating space and the temperature-maintained space. A height of the second preheating space may gradually increase toward the temperature-maintained space. A length of the second preheating space in the conveying direction may be equal to or greater than a length of the treatment object in the conveying direction. According to the above configuration, the atmospheric gas in the temperature-maintained space can easily flow through the second preheating space into the first preheating space. Due to this, the heat in the temperature-maintained space can raise the temperature of the first preheating space and the temperature of the second preheating space.

In a tenth aspect of the art disclosed herein according to the eighth or ninth aspect, when the furnace body is cut along a plane perpendicular to the conveying direction, an inner width of the temperature-maintained space may be greater than an inner width of the preheating space. According to the above configuration, there will be even less variation in the temperature of the temperature-maintained space. Due to this, generation of variation in the heating amount on a treatment object can be further suppressed in the temperature-maintained space.

In an eleventh aspect of the art disclosed herein according to any one of the first to tenth aspects, the cross-sectional area of the temperature-maintained space may be constant along the conveying direction. According to the above configuration, there will be less variation in the temperature of the temperature-maintained space. Due to this, generation of variation in the heating amount on a treatment object can be further suppressed in the temperature-maintained space.

### First Embodiment

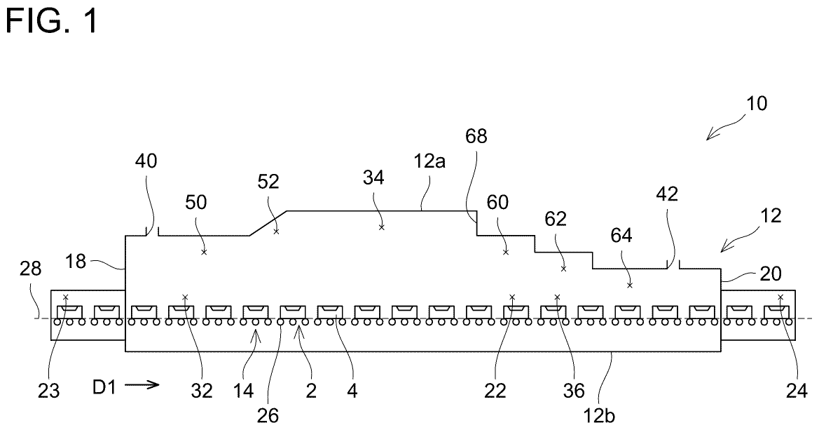

A furnace 10 according to a first embodiment illustrated in FIG. 1 heats treatment objects 2. The treatment objects 2 include saggars 4. Each saggar 4 has a substantially cuboid box shape. Each saggar 4 accommodates a treatment object body therein. The treatment object body is raw material(s) for a ceramic capacitor, powder of a positive material or a negative material of a lithium-ion battery, for example.

The furnace 10 comprises a furnace body 12 and a conveying device 14.

The furnace body 12 is a thermally insulated structure with an elongated shape. Inside of the furnace body 12 is filled with atmospheric gas. The atmospheric gas is for example a nitrogen gas. The furnace body 12 has an entrance 18, an exit 20, and an internal space 22. The entrance 18 is arranged at one end of the furnace body 12 in its longitudinal direction. The exit 20 is arranged at another end of the furnace body 12 in its longitudinal direction. The internal space 22 is communicated with a first space 23 through the entrance 18, and is communicated with a second space 24 through the exit 20. The first space 23 and the second space 24 are communicated with a space outside the furnace body 12. In a modification, the first space 23 and the second space 24 may not be formed. In this configuration, the internal space 22 may be communicated with the space outside the furnace body 12 respectively through the entrance 18 and the exit 20.

The conveying device 14 is for example a roller-type conveying device. In a modification, the conveying device 14 may be a pusher-type conveying device comprising a pusher configured to push a conveying plate or a cart including wheel(s). The conveying device 14 comprises a plurality of rollers 26 arranged in the longitudinal direction of the furnace body 12. Boths ends of the rollers 26 are rotatably supported. The plurality of rollers 26 rotates by being driven by a driving device (not illustrated). The treatment objects 2 are configured to be placed on a conveying surface 28 of the conveying device 14. Here, one treatment object 2 may be placed on the conveying surface 28, or a plurality of treatment objects 2 may be placed on the conveying surface 28 in a stacked state in an up-down direction. The conveying surface 28 is a surface which includes upper ends of the plurality of rollers 26, and extends along a conveying direction D1. The conveying device 14 conveys the treatment objects 2 in the conveying direction D1 by rotation of the plurality of rollers 26 with the treatment objects 2 placed on the conveying surface 28. Due to this, the treatment objects 2 are conveyed through the entrance 18 from the first space 23 to the internal space 22, and after passing through the internal space 22, they are conveyed out through the exit 20 into the second space 24. Here, the conveying direction D1 is substantially equal to the longitudinal direction of the furnace body 12.

The internal space 22 comprises a preheating space 32, a temperature-maintained space 34, and a cooling space 36. The preheating space 32, the temperature-maintained space 34, and the cooling space 36 are aligned in this order in the conveying direction D1.

The preheating space 32 is communicated with the entrance 18. The preheating space 32 has a plurality of heaters (not illustrated) disposed therein. A temperature of the preheating space 32 gradually increases from the entrance 18 toward the exit 20 (i.e., further ahead in the conveying direction D1). The preheating space 32 preheats the treatment objects 2 (i.e., treatment object bodies) as the treatment objects 2 pass through the preheating space 32. When the treatment object bodies are preheated, gas is generated from the treatment object bodies.

The furnace body 12 has a first vent 40, and the preheating space 32 is communicated with the first vent 40. The first vent 40 is arranged, for example, proximate the entrance 18. The first vent 40 extends through a roof wall 12a of the furnace body 12. In the preheating space 32, a plurality of air supply pipes (not illustrated) configured to supply the atmospheric gas is disposed. The atmospheric gas is firstly supplied from the plurality of air supply pipes to the preheating space 32, and then the atmospheric gas flows in the preheating space 32 in an opposite direction from the conveying direction D1, and is discharged from the first vent 40 to a space outside the furnace body 12. Also, the atmospheric gas is discharged to the space outside the furnace body 12 along with the gas generated from the treatment object bodies.

The temperature-maintained space 34 is communicated with the preheating space 32. The temperature-maintained space 34 has a plurality of heaters (not illustrated) disposed therein. A temperature of the temperature-maintained space 34 is maintained substantially constant. The temperature of the temperature-maintained space 34 is higher than the temperature of the preheating space 32. The temperature-maintained space 34 heats (i.e., fires) the treatment objects 2 as the treatment objects 2 pass through the temperature-maintained space 34.

The temperature-maintained space 34 has a plurality of air supply pipes (not illustrated) configured to supply the atmospheric gas disposed therein. The atmospheric gas is firstly supplied from the plurality of air supply pipes to the temperature-maintained space 34, and then the atmospheric gas flows in the temperature-maintained space 34 in the opposite direction from the conveying direction D1, and is discharged to the preheating space 32. Due to this, the heat in the temperature-maintained space 34 can be utilized to increase the temperature of the preheating space 32.

The cooling space 36 is communicated with the temperature-maintained space 34 and the exit 20. The cooling space 36 has a plurality of cooling pipes (not illustrated) configured to allow coolant to pass therethrough arranged therein. A temperature of the cooling space 36 gradually decreases toward the exit 20 (i.e., further ahead in the conveying direction D1). The temperature of the cooling space 36 is lower than the temperature of the temperature-maintained space 34. The cooling space 36 cools the treatment objects 2 as the treatment objects 2 pass through the cooling space 36.

The furnace body 12 has a second vent 42, and the cooling space 36 is communicated with the second vent 42. The second vent 42 is arranged, for example, proximate the exit 20. The second vent 42 extends through the roof wall 12a of the furnace body 12. The cooling space 36 has a plurality of air supply pipes (not illustrated) configured to supply the atmospheric gas disposed therein. The atmospheric gas is firstly supplied from the plurality of air supply pipes to the cooling space 36, and then the atmospheric gas flows in the cooling space 36 in the conveying direction D1, and is discharged through the second vent 42 to the space outside the furnace body 12.

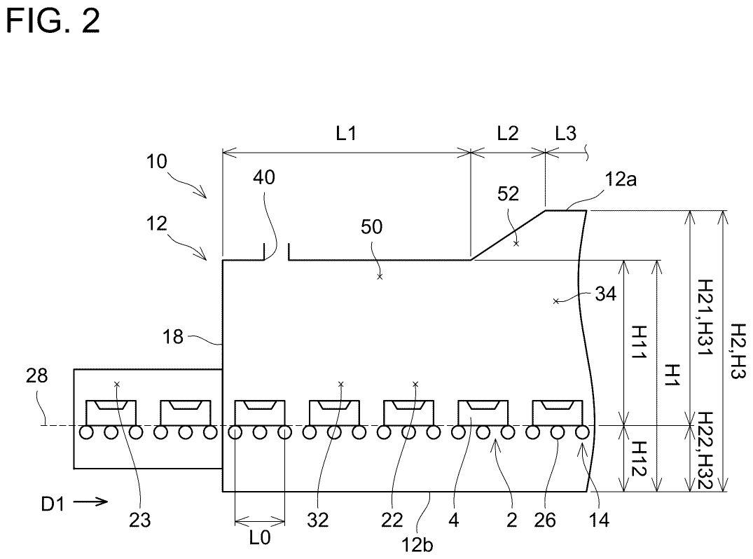

As illustrated in FIG. 2, the preheating space 32 comprises a first preheating space 50 and a second preheating space 52. The first preheating space 50 and the second preheating space 52 are aligned in this order in the conveying direction D1. The first preheating space 50 is communicated with the entrance 18 and the first vent 40. The second preheating space 52 is communicated with the first preheating space 50 and the temperature-maintained space 34.

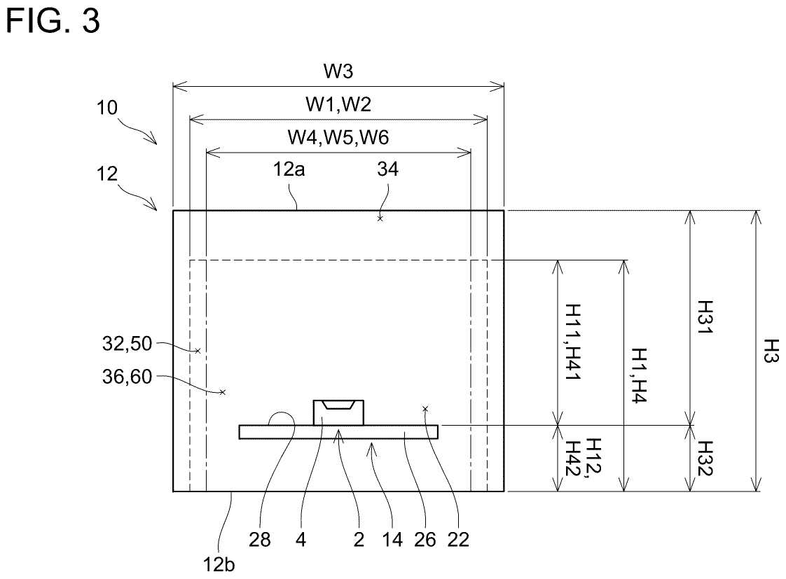

A length L1 of the first preheating space 50 in the conveying direction D1 is longer than a length L0 of each treatment object 2 in the conveying direction D1. A height H1 (i.e., distance in the up-down direction from the roof wall 12a to a floor wall 12b of the furnace body 12) of the first preheating space 50 is substantially constant along the conveying direction D1. Also, a height H11 of the first preheating space 50 from the conveying surface 28 to the roof wall 12a is substantially constant along the conveying direction D1. Further, a height H12 of the first preheating space 50 from the conveying surface 28 to the floor wall 12b is substantially constant along the conveying direction D1. As illustrated in FIG. 3, when the furnace body 12 is cut along a plane perpendicular to the conveying direction D1, an inner width W1 of the first preheating space 50 is substantially constant along the conveying direction D1. In FIG. 3, the first preheating space 50 is indicated in broken lines. A cross-sectional area of the first preheating space 50 is substantially constant along the conveying direction D1.

As illustrated in FIG. 2, a length L2 of the second preheating space 52 in the conveying direction D1 is longer than the length L0 of each treatment object 2, and is shorter than the length L1 of the first preheating space 50. When the furnace body 12 is cut along the plane perpendicular to the conveying direction D1, a height H2 (i.e., distance in the up-down direction between the roof wall 12a and the floor wall 12b of the furnace body 12) of the second preheating space 52 is equal to or longer than the height H1 of the first preheating space 50. The height H2 of the second preheating space 52 gradually increases from the first preheating space 50 toward the temperature-maintained space 34. When the furnace body 12 is cut along the plane perpendicular to the conveying direction D1, a height H21 of the second preheating space 52 from the conveying surface 28 to the roof wall 12a is equal to or longer than the height H11 of the first preheating space 50. The height H21 of the second preheating space 52 gradually increases from the first preheating space 50 to the temperature-maintained space 34. When the furnace body 12 is cut along the plane perpendicular to the conveying direction D1, a height H22 in the second preheating space 52 from the conveying surface 28 to the floor wall 12b is substantially equal to the height H12 of the first preheating space 50. The height H22 of the second preheating space 52 is substantially constant along the conveying direction D1. As illustrated in FIG. 3, when the furnace body 12 is cut along the plane perpendicular to the conveying direction D1, an inner width W2 of the second preheating space 52 is substantially equal to the inner width W1 of the first preheating space 50. The inner width W2 of the second preheating space 52 is substantially constant along the conveying direction D1. When the furnace body 12 is cut along the plane perpendicular to the conveying direction D1, a cross-sectional area of the second preheating space 52 is equal to or greater than the cross-sectional area of the first preheating space 50. The cross-sectional area of the second preheating space 52 increases toward the conveying direction D1.

As illustrated in FIG. 2, a length L3 of the temperature-maintained space 34 in the conveying direction D1 is longer than the length L0 of each treatment object 2. The length L3 of the temperature-maintained space 34 is longer than the length L2 of the second preheating space 52. A height H3 (i.e., distance in the up-down direction between the roof wall 12a and the floor wall 12b of the furnace body 12) of the temperature-maintained space 34 is substantially constant along the conveying direction D1. When the furnace body 12 is cut along the plane perpendicular to the conveying direction D1, the height H3 of the temperature-maintained space 34 is higher than the height H1 of the first preheating space 50, and is substantially equal to the height H2 of the second preheating space 52 at a boundary between the second preheating space 52 and the temperature-maintained space 34. The height H3 of the temperature-maintained space 34 is equal to or more than 1.1 times the height H1 of the first preheating space 50. A height H31 in the temperature-maintained space 34 from the conveying surface 28 to the roof wall 12a is substantially constant along the conveying direction D1. When the furnace body 12 is cut along the plane perpendicular to the conveying direction D1, the height H31 of the temperature-maintained space 34 is higher than the height H11 of the first preheating space 50, and is substantially equal to the height H21 of the second preheating space 52 at the boundary between the second preheating space 52 and the temperature-maintained space 34. A height H32 in the temperature-maintained space 34 from the conveying surface 28 to the floor wall 12b is substantially constant along the conveying direction D1. When the furnace body 12 is cut along the plane perpendicular to the conveying direction D1, the height H32 of the temperature-maintained space 34 is substantially equal to each of the height H12 of the first preheating space 50 and the height H22 of the second preheating space 52. In a modification, the height H32 may be different from each of the height H12 and the height H22. In this configuration, the height H31 of the temperature-maintained space 34 may be equal to or different from each of the height H11 of the first preheating space 50 and the height H21 of the second preheating space 52. As illustrated in FIG. 3, when the furnace body 12 is cut along the plane perpendicular to the conveying direction D1, an inner width W3 of the temperature-maintained space 34 is greater than each of the inner width W1 of the first preheating space 50 and the inner width W2 of the second preheating space 52. The inner width W3 of the temperature-maintained space 34 is substantially constant along the conveying direction D1. When the furnace body 12 is cut along the plane perpendicular to the conveying direction D1, the cross-sectional area of the temperature-maintained space 34 is greater than each of the cross-sectional area of the first preheating space 50 and the cross-sectional area of the second preheating space 52. The cross-sectional area of the temperature-maintained space 34 is equal to or more than 1.1 times the cross-sectional area of the first preheating space 50. The cross-sectional area of the temperature-maintained space 34 is substantially constant along the conveying direction D1.

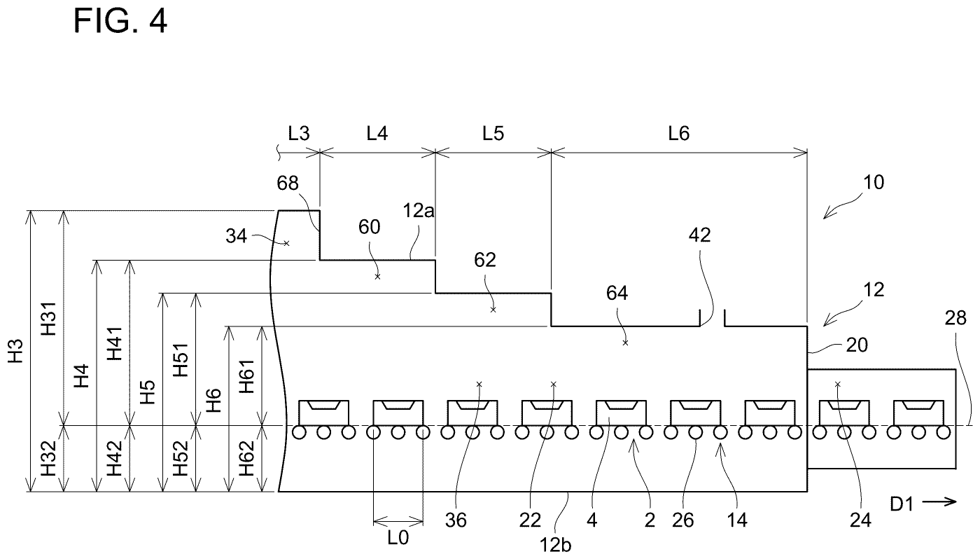

As illustrated in FIG. 4, the cooling space 36 comprises a first cooling space 60, a second cooling space 62, and a third cooling space 64. The first cooling space 60, the second cooling space 62, and the third cooling space 64 are aligned in this order in the conveying direction D1. The first cooling space 60 is communicated with the temperature-maintained space 34. The second cooling space 62 is communicated with the first cooling space 60. The third cooling space 64 is communicated with the second cooling space 62, the exit 20, and the second vent 42.

A length L4 of the first cooling space 60 in the conveying direction D1 is longer than the length L0 of each treatment object 2. The length L4 of the first cooling space 60 is longer than the length L2 of the second preheating space 52, and is shorter than each of the length L1 of the first preheating space 50 and the length L3 of the temperature-maintained space 34. A height H4 (i.e., a distance in the up-down direction between the roof wall 12a and the floor wall 12b of the furnace body 12) of the first cooling space 60 is substantially constant along the conveying direction D1. The height H4 of the first cooling space 60 is greatest within the cooling space 36. When the furnace body 12 is cut along the plane perpendicular to the conveying direction D1, the height H4 of the first cooling space 60 is equal to or lower than the height H1 of the first preheating space 50, and is lower than each of the height H2 of the second preheating space 52 and the height H3 of the temperature-maintained space 34. The height H3 of the temperature-maintained space 34 is equal to or more than 1.1 times the height H4 of the first cooling space 60. Due to this, a step 68 is formed between the temperature-maintained space 34 and the first cooling space 60. Due to this, the atmospheric gas in the temperature-maintained space 34 can be suppressed from flowing into the first cooling space 60. A height H41 of the first cooling space 60 from the conveying surface 28 to the roof wall 12a is substantially constant along the conveying direction D1. When the furnace body 12 is cut along the plane perpendicular to the conveying direction D1, the height H41 of the first cooling space 60 is equal to or lower than the height H11 of the first preheating space 50, and is lower than each of the height H21 of the second preheating space 52 and the height H31 of the temperature-maintained space 34. A height H42 in the first cooling space 60 from the conveying surface 28 to the floor wall 12b is substantially constant along the conveying direction D1. When the furnace body 12 is cut along the plane perpendicular to the conveying direction D1, the height H42 of the first cooling space 60 is substantially equal to the height H32 of the temperature-maintained space 34. As illustrated in FIG. 3, when the furnace body 12 is cut along the plane perpendicular to the conveying direction D1, an inner width W4 of the first cooling space 60 is smaller than each of the inner width W1 of the first preheating space 50, the inner width W2 of the second preheating space 52, and the inner width W3 of the temperature-maintained space 34. Here, in FIG. 3, the first cooling space 60 is shown in one-dot dashed line. The inner width W4 of the first cooling space 60 is substantially constant along the conveying direction D1. When the furnace body 12 is cut along the plane perpendicular to the conveying direction D1, a cross-sectional area of the first cooling space 60 is greatest within the cooling space 36. The cross-sectional area of the first cooling space 60 is substantially constant along the conveying direction D1. The cross-sectional area of the first cooling space 60 is equal to or smaller than the cross-sectional area of the first preheating space 50, and is smaller than each of the cross-sectional area of the second preheating space 52 and the cross-sectional area of the temperature-maintained space 34. As such, in the furnace body 12, the cross-sectional area of the temperature-maintained space 34 is larger than each of the cross-sectional area of the preheating space 32 and the cross-sectional area of the cooling space 36. Due to this, even when the atmospheric gas flows in the temperature-maintained space 34, the atmosphere in the temperature-maintained space 34 changes less, resulting in less generation of variation in the temperature of the temperature-maintained space 34. Due to this, generation of variation in the heating amount on the treatment objects 2 in the temperature-maintained space 34 can be suppressed. Also, when the cross-sectional area of the first cooling space 60 is smaller than the cross-sectional area of the preheating space 32, the atmospheric gas in the temperature-maintained space 34 can more easily flow into the preheating space 32. Due to this, the temperature of the first cooling space 60 can be easily adjusted. The cross-sectional area of the temperature-maintained space 34 is equal to or more than 1.1 times the cross-sectional area of the first cooling space 60. The cross-sectional area of the first preheating space 50 is equal to or greater than the cross-sectional area of the first cooling space 60.

As illustrated in FIG. 4, a length L5 of the second cooling space 62 in the conveying direction D1 is longer than the length L0 of each treatment object 2, and is substantially equal to the length L4 of the first cooling space 60. A height H5 (i.e., distance in the up-down direction between the roof wall 12a and the floor wall 12b of the furnace body 12) of the second cooling space 62 is substantially constant along the conveying direction D1. When the furnace body 12 is cut along the plane perpendicular to the conveying direction D1, the height H5 of the second cooling space 62 is lower than the height H4 of the first cooling space 60. The height H5 of the second cooling space 62 is equal to or less than 0.9 times the height H4 of the first cooling space 60. The height H51 of the second cooling space 62 from the conveying surface 28 to the roof wall 12a is substantially constant along the conveying direction D1. When the furnace body 12 is cut along the plane perpendicular to the conveying direction D1, the height H51 of the second cooling space 62 is lower than the height H41 of the first cooling space 60. The height H51 of the second cooling space 62 is equal to or less than 0.9 times the height H41 of the first cooling space 60. A height H52 of the second cooling space 62 from the conveying surface 28 to the floor wall 12b is substantially constant along the conveying direction D1. When the furnace body 12 is cut along the plane perpendicular to the conveying direction D1, the height H52 of the second cooling space 62 is substantially equal to the height H42 of the first cooling space 60. As illustrated in FIG. 3, when the furnace body 12 is cut along the plane perpendicular to the conveying direction D1, an inner width W5 of the second cooling space 62 is substantially equal to the inner width W4 of the first cooling space 60. The inner width W5 of the second cooling space 62 is substantially constant along the conveying direction D1. When the furnace body 12 is cut along the plane perpendicular to the conveying direction D1, a cross-sectional area of the second cooling space 62 is smaller than the cross-sectional area of the first cooling space 60. The cross-sectional area of the first cooling space 60 is larger than the cross-sectional area of the second cooling space 62. The cross-sectional area of the second cooling space 62 is substantially constant along the conveying direction D1.

As illustrated in FIG. 4, a length L6 of the third cooling space 64 in the conveying direction D1 is longer than each of the length L0 of each treatment object 2, the length L4 of the first cooling space 60, and the length L5 of the second cooling space 62. A sum of the lengths L4, L5, L6 (i.e., length of the cooling space 36 in the conveying direction D1) is longer than each of the length of the preheating space 32 in the conveying direction D1 (i.e., sum of the lengths L1, L2) and the length L3 of the temperature-maintained space 34 in the conveying direction D1. A height H6 (i.e., distance in the up-down direction between the roof wall 12a and the floor wall 12b of the furnace body 12) of the third cooling space 64 is substantially constant along the conveying direction D1. The height H6 of the third cooling space 64 is lower than the height H5 of the second cooling space 62. The height H6 of the third cooling space 64 is equal to or less than 0.9 times the height H5 of the second cooling space 62. Due to this, the height of the cooling space 36 decreases in steps in the conveying direction D1 (i.e., toward the exit 20). A height H61 of the third cooling space 64 from the conveying surface 28 to the roof wall 12a is substantially constant along the conveying direction D1. When the furnace body 12 is cut along the plane perpendicular to the conveying direction D1, the height H61 of the third cooling space 64 is lower than the height H51 of the second cooling space 62. The height H61 of the third cooling space 64 is equal to or less than 0.9 times the height H51 of the second cooling space 62. A height H62 of the third cooling space 64 from the conveying surface 28 to the floor wall 12b is substantially constant along the conveying direction D1. When the furnace body 12 is cut along the plane perpendicular to the conveying direction D1, a height H62 of the third cooling space 64 is substantially equal to the height H52 of the second cooling space 62. As illustrated in FIG. 3, when the furnace body 12 is cut along the plane perpendicular to the conveying direction D1, an inner width W6 of the third cooling space 64 is substantially equal to the inner width W5 of the second cooling space 62. The inner width W6 of the third cooling space 64 is substantially constant along the conveying direction D1. When the furnace body 12 is cut along the plane perpendicular to the conveying direction D1, a cross-sectional area of the third cooling space 64 is smaller than the cross-sectional area of the second cooling space 62. Thus, the cross-sectional area of the third cooling space 64 is smallest within the cooling space 36, and also is smallest within the furnace body 12. The cross-sectional area of the second cooling space 62 is greater than the cross-sectional area of the third cooling space 64. The cross-sectional area of the third cooling space 64 is substantially constant along the conveying direction D1.

### (Effects)

In the above first embodiment, when the furnace body 12 is cut along the plane perpendicular to the conveying direction D1, the cross-sectional area of the temperature-maintained space 34 is greater than the cross-sectional area of the preheating space 32. According to the above configuration, as compared to a configuration where the cross-sectional area of the temperature-maintained space 34 is smaller than the cross-sectional area of the preheating space 32 when the furnace body 12 is cut along the plane perpendicular to the conveying direction D1, variation caused by disturbance in the atmosphere in the temperature-maintained space 34 is small, resulting in less variation in the temperature in the temperature-maintained space 34. Due to this, generation of variation in the heating amount on the treatment objects 2 can be suppressed in the temperature-maintained space 34.

### (Correspondence Relationships)

The height H4 is an example for “first height”. The height H5 is an example for “second height”.

### Second Embodiment

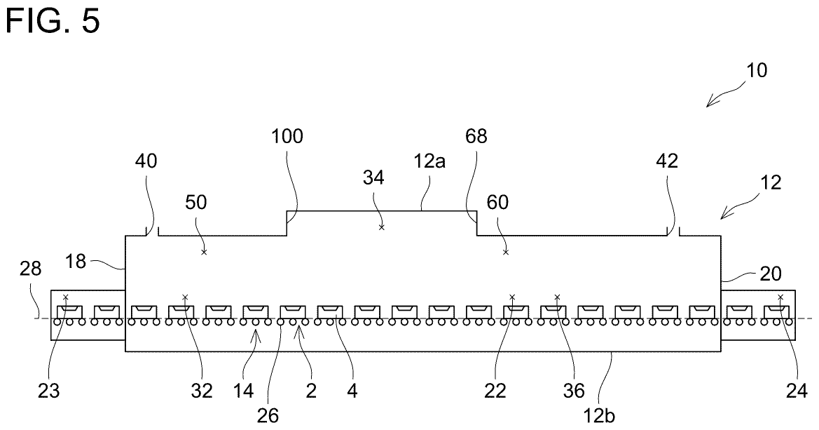

In the second embodiment, only the points different from the first embodiment will be described. As illustrated in FIG. 5, a preheating space 32 comprises only a first preheating space 50, that is, does not comprise the second preheating space 52 of the first embodiment. A length L1 of the first preheating space 50 corresponds to a length of a preheating space 32 in the conveying direction D1. The first preheating space 50 is communicated with an entrance 18 and a temperature-maintained space 34. Since a height H3 of the temperature-maintained space 34 is higher than a height H1 of the first preheating space 50, a step 100 is formed between the temperature-maintained space 34 and the first preheating space 50.

A cooling space 36 comprises a first cooling space 60 only, that is, it does not comprise the second cooling space 62 and the third cooling space 64 of the first embodiment. The first cooling space 60 is communicated with the temperature-maintained space 34 and an exit 20. A length L4 of the first cooling space 60 corresponds to a length of the cooling space 36 in the conveying direction D1, and is longer than each of a length of the preheating space 32 and a length L3 of the temperature-maintained space 34 in the conveying direction D1.

### (Modifications)

In an embodiment, the cooling space 36 may not comprise the third cooling space 64. Also, the cooling space 36 may further comprise N cooling space(s). N is a natural number. In an embodiment, when the furnace body 12 is cut along the plane perpendicular to the conveying direction D1, the cross-sectional area of the cooling space 36 may be substantially equal to the cross-sectional area of the preheating space 32.

In an embodiment, when the furnace body 12 is cut along the plane perpendicular to the conveying direction D1, at least one of the cross-sectional area of the first preheating space 50, the cross-sectional area of the temperature-maintained space 34, the cross-sectional area of the first cooling space 60, the cross-sectional area of the second cooling space 62, and the cross-sectional area of the third cooling space 64 may vary along the conveying direction D1.

In an embodiment, when the furnace body 12 is cut along the plane perpendicular to the conveying direction D1, at least one of the inner widths W1, W2, W3, W4, W5, and W6 may vary along the conveying direction D1. Further, the inner widths W1, W2, W3, W4, W5, W6 may be substantially equal to each other.

In an embodiment, at least one of the heights H1, H3, H4, H5, H6 may vary in the conveying direction D1. Also, at least one of the heights H11, H31, H41, H51, H61 may vary in the conveying direction D1. Further, at least one of the heights H12, H22, H32, H42, H52, H62 may vary in the conveying direction D1.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A furnace configured to heat a treatment object, the furnace comprising:
a furnace body including an entrance, an exit, and an internal space extending in a conveying direction from the entrance to the exit; and
a conveying device having a conveying surface configured to carry the treatment object thereon and configured to convey the treatment object in the conveying direction,
wherein the internal space comprises:
a preheating space communicated with the entrance and configured to preheat the treatment object;
a temperature-maintained space communicated with the preheating space and configured to heat the treatment object, wherein a temperature in the temperature-maintained space is maintained constant; and
a cooling space communicated with the temperature-maintained space and the exit and configured to cool the treatment object, and
when the furnace body is cut along a plane perpendicular to the conveying direction, a cross-sectional area of the temperature-maintained space is greater than a cross-sectional area of the preheating space.

2. The furnace according to claim 1, wherein when the furnace body is cut along a plane perpendicular to the conveying direction, the cross-sectional area of the temperature-maintained space is greater than a cross-sectional area of the cooling space.

3. The furnace according to claim 2, wherein when the furnace body is cut along a plane perpendicular to the conveying direction, the cross-sectional area of the cooling space is smaller than the cross-sectional area of the preheating space.

4. The furnace according to claim 2, wherein when the furnace body is cut along a plane perpendicular to the conveying direction, a height of the temperature-maintained space is equal to or more than 1.1 times a height of the cooling space.

5. The furnace according to claim 4, wherein the height of the cooling space decreases in steps toward the exit.

6. The furnace according to claim 5, wherein the cooling space comprises:
a first cooling space a height of which is a first height; and
a second cooling space communicated with the first cooling space, located in the conveying direction with respect to the first cooling space, and a height of which is a second height,
the second height is equal to or less than 0.9 times the first height, and
a length of the first cooling space in the conveying direction and a length of the second cooling space in the conveying direction are each equal to or greater than a length of the treatment object in the conveying direction.

7. The furnace according to claim 4, wherein when the furnace body is cut along a plane perpendicular to the conveying direction, an inner width of the temperature-maintained space is greater than an inner width of the cooling space.

8. The furnace according to claim 1, wherein the preheating space comprises a first preheating space, and
when the furnace body is cut along a plane perpendicular to the conveying direction, a height of the temperature-maintained space is equal to or more than 1.1 times a height of the first preheating space.

9. The furnace according to claim 8, wherein the preheating space further comprises a second preheating space communicated with the first preheating space and the temperature-maintained space,
a height of the second preheating space gradually increases toward the temperature-maintained space, and
a length of the second preheating space in the conveying direction is equal to or greater than a length of the treatment object in the conveying direction.

10. The furnace according to claim 8, wherein when the furnace body is cut along a plane perpendicular to the conveying direction, an inner width of the temperature-maintained space is greater than an inner width of the preheating space.

11. The furnace according to claim 1, wherein the cross-sectional area of the temperature-maintained space is constant along the conveying direction.
